(19) United States
(12) Patent Application Publication
(10) Pub. No.: US 2006/0051708 A1
(43) Pub. Date: Mar. 9, 2006

(54) Plasma display panel and manufacturing method thereof

(76) Inventors: Jong Rae Lim, Anyang-si (KR); Woo Tae Kim, Yongin-si (KR)

Correspondence Address: MCKENNA LONG & ALDRIDGE LLP;Song K. Jung, 1900 K Street, N.W., Washington, DC, 20006, US

(21) Appl. No.: 11/219,861

(22) Filed: Sep. 7, 2005

(30) Foreign Application Priority Data
Sep. 7, 2004 (KR) 10-2004-0071469

(51) Int. Cl. H01J 17/49

(52) U.S. Cl. 430/321; 313/582; 313/586; 313/292; 216/24

(57) ABSTRACT

The present invention relates to a plasma display panel and a manufacturing method thereof, and more particularly, to a plasma display panel including barrier ribs and a manufacturing method thereof. A method of manufacturing a plasma display panel according to the present invention comprises the steps of stacking a plurality of barrier rib material layers with different etch rate from each other on a glass substrate; and forming the barrier rib through etching said plurality of barrier rib material layers with different etch rate from each other. The present invention may secure the maximum area of the discharge cell as well as the structural stability of the barrier rib.

### CROSS-REFERENCES TO RELATED APPLICATIONS

This Non provisional application claims priority under 35 U.S.C. § 119(a) on Patent Application No. 2004-0071469 filed in Korea on Sep. 7, 2004 the entire contents of which are hereby incorporated by reference.

### BACKGROUND OF THE INVENTION

1. Field of the Invention

The present invention relates to a plasma display panel and a manufacturing method thereof, and more particularly, to a plasma display panel including barrier ribs and a manufacturing method thereof

2. Background of the Related Art

In general, a plasma display panel is a device, where a single unit cell is composed of barrier ribs formed between a front substrate and a rear substrate made of soda-lime glass, and in each cell, vacuum ultraviolet rays are generated when inert gases such as He—Xe, He—Ne or like are discharged by a high frequency voltage, and it allows a phosphor formed within barrier ribs to radiate light, thus implementing a image.

FIG. 1 is a prospective view schematically showing a conventional plasma display panel. As shown in FIG. 1, the plasma display panel is composed of a front glass substrate 10 and a rear glass substrate 20 combined in parallel with each other in a predetermined distance.

A scan electrode 11 and a sustain electrode 12 are formed on the front glass substrate 10 so as to maintain the radiation of cell. The scan electrode 11 and the sustain electrode is comprised of a transparent electrode 11a, 12a formed of transparent ITO material, and a bus electrode 11b, 12b made of metal material, respectively.

A scan signal for scanning a panel and a sustain signal for maintaining a discharge are primarily supplied to the scan electrode 11. And, a sustain signal is supplied to said sustain electrode 12.

A dielectric layer 13a covers the scan electrode 11 and the sustain electrode 12 in order to limit the discharge current and insulate a pair of electrodes. A protective layer is formed on top surface of the dielectric layer 13a to ease the emission of secondary electrons.

Barrier ribs 21 are formed on the rear glass substrate 20 to form discharge cells. An address electrode 22 is formed on the rear glass substrate 20 and arranged in parallel with the barrier ribs 21. A dielectric layer 13b is formed on top surface of the address electrode 22. R, G, B phosphor layers 23 which emit a visible ray are applied on the dielectric layer 13b.

The front glass substrate 10 and the rear glass substrate 20 are bonded by a Frit glass, and then an exhaust process is performed so as to remove impurities in the panel. Thereafter, inert gases such as He, Ne, Xe or like are injected into the plasma display panel to raise the efficiency of discharge.

FIG. 2 is a view subsequently showing the process of forming the barrier ribs of the conventional plasma display panel.

First, the address electrode 22 having a constant width and height is form on the rear glass substrate 20 in step (a), the dielectric layer 13b is formed on the address electrode 22 in step (b).

A barrier rib material layer 21 is formed on the dielectric layer 13b in step (c), a photoresist is stacked on the barrier rib material layer 21 in step (d). In step (e) the photomask 32 on which a predetermined pattern is formed is placed on the photoresist 30, and then the photo resist 30 is allowed to be cured through illuminating the light. This process is referred to as exposing process. After the exposing process, the photoresist 30 which is not cured is washed out through development process, and then it is etched in step (g) to thereby form the barrier rib 21. Thereafter, the barrier rib 21 is completed through drying and then baking the formed barrier rib 21.

In step (h), a phosphor layer is formed between the barrier ribs 21, and then the rear glass substrate 20 is formed through baking.

The barrier ribs which are formed through this process is shown in FIGS. 3a and 3b.

FIG. 3a is a structure of barrier ribs of the conventional plasma display panel, and FIG. 3b is another structure of barrier ribs of the conventional plasma display panel.

As shown in FIG. 3a, in case where the width of lower part of the barrier rib is wide, the stability of the barrier rib 21 increases, however, the area of a discharge cell is decreased. In case where the area of the discharge cell is decreased due to increasing of the width of lower part of the barrier rib, the brightness of the plasma display panel is lessened. In addition, in case of the plasma display panel which supports high resolution the area of the discharge cell is decreased, so that it becomes more difficult to implement the discharge cell of the plasma display panel supporting high resolution, if the width of lower part of the barrier rib is great.

As shown in FIG. 3b, if the width of lower part of the barrier rib 21 is formed narrowly to maximize the area of the discharge cell, then the width of middle part of the barrier rib 21 is narrower than that of lower part of the barrier rib 21 due to etching. Accordingly, there is a problem that the area of the discharge cell is broaden, however, the barrier rib 21 collapses.

### SUMMARY OF THE INVENTION

Accordingly, an object of the present invention is to solve at least the problems and disadvantages of the background art.

Another object of the present invention is to provide the structural stability of barrier ribs.

Still another object of the present invention is to maximize the area of a discharge cell to thereby warrant the high brightness of a plasma display panel.

A method of manufacturing a plasma display panel according to the present invention comprises the steps of stacking a plurality of barrier rib material layers with different etch rate from each other on a glass substrate; and forming the barrier rib through etching said plurality of barrier rib material layers with different etch rate from each other.

A plasma display panel according to the present invention includes a glass substrate, and a barrier rib formed of a plurality of barrier rib material with different etch rate from each other on said glass substrate.

The present invention may secure the area of a discharge cell through forming a plurality of barrier rib layers with different etch rate from each other.

The present invention may improve the brightness of a plasma display panel through forming a plurality of barrier rib layers with different etch rate from each other.

The present invention may provide a discharge cell of a plasma display panel which supports the high resolution through forming a plurality of barrier rib layers with different etch rate from each other.

The present invention may secure the structural stability of the barrier rib through forming a plurality of barrier rib layers with different etch rate from each other.

### BRIEF DESCRIPTION OF THE DRAWINGS

The invention will be described in detail with reference to the following drawings in which like numerals refer to like elements.

FIG. 1 is a perspective view schematically showing the device structure of a conventional plasma display panel.

FIG. 2 is a view sequentially showing a process of forming a barrier rib of a conventional plasma display panel.

FIG. 3a is a view showing a barrier rib of a conventional plasma display panel.

FIG. 3b is a view showing another barrier rib of a conventional plasma display panel.

FIG. 4 is a process view schematically showing a process of manufacturing a plasma display panel of the present invention.

FIG. 5a is a structure of a barrier rib of a plasma display panel of the present invention.

FIG. 5b is another structure of a barrier rib of a plasma display panel of the present invention.

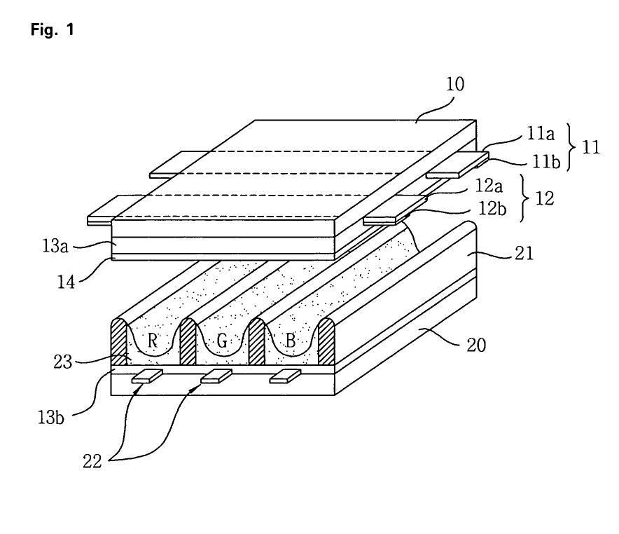

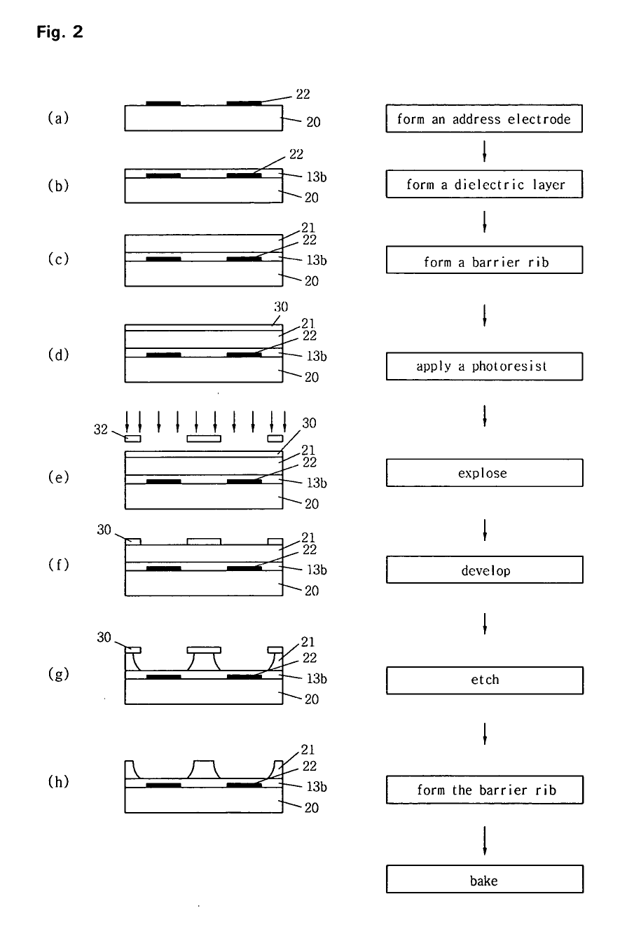

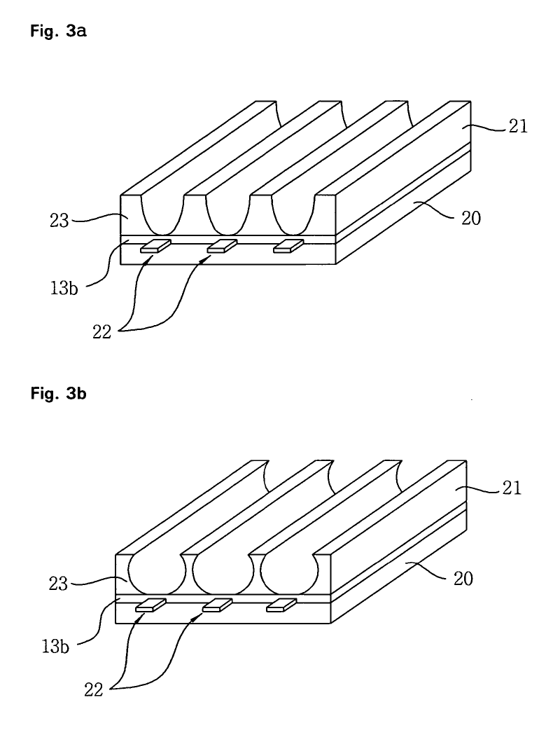

### DETAILED DESCRIPTION OF THE PREFERRED EMBODIMENT

Preferred embodiments of the present invention will be described in a more detailed manner with reference to the drawings.

A plasma display panel according to the present invention includes a display panel, a frame formed on the rear surface of said display panel, and at least two or more thermal conductive sheets formed on a surface between said display panel and said frame, wherein said thermal conductive sheets are separated and spaced apart with a predetermined interval. A method of manufacturing the plasma display panel of the present invention includes the steps of stacking a plurality of barrier rib material layers with different etch rate from each other on a glass substrate; and forming the barrier rib through etching said plurality of barrier rib material layers with different etch rate from each other.

As becoming more distant from said glass substrate, so the barrier rib material layer with low etch rate is stacked thereon.

A method of manufacturing the plasma display panel of the present invention includes further steps of forming a photoresist on top barrier rib material layer after stacking said barrier rib material layer, expose said photoresist using a mask, and developing a pattern formed through said exposing.

Said etching is performed using a sandblast method.

Said etching is performed using an etch solution.

Each of said plurality of barrier rib material layers different from each other includes a filler, whose content is different from each other.

Said filler includes one or more than one of Al2O3, TiO2 and ZnO, whose content is different from each other.

Each of said plurality of barrier rib material layers different from each other includes glass powder, wherein an additive oxide added to said powder glass is different from each other.

A diameter of a particle of said glass powder is different from each other.

Each of said plurality of barrier rib material layers different from each other includes a vehicle, and said vehicle includes a binder different from each other.

A plasma display panel of the present invention includes a barrier rib formed of a plurality of barrier rib material layers with different etch rate from each other.

As said barrier rib becomes more distant from said glass substrate, so barrier rib material layer with low etch rate is stacked thereon.

Each of said plurality of barrier rib material layers different from each other includes a filler, whose content is different from each other.

Said filler includes one or more than one of Al2O3, TiO2 and ZnO, whose content is different from each other.

Each of said plurality of barrier rib material layers different from each other includes glass powder, wherein an additive oxide added to said powder glass is different from each other.

A diameter of a particle of said glass powder is different from each other.

Each of said plurality of barrier rib material layers different from each other includes a vehicle, and said vehicle includes a binder different from each other.

Hereinafter, specific embodiments according to the present invention will be described with reference to accompanying figures.

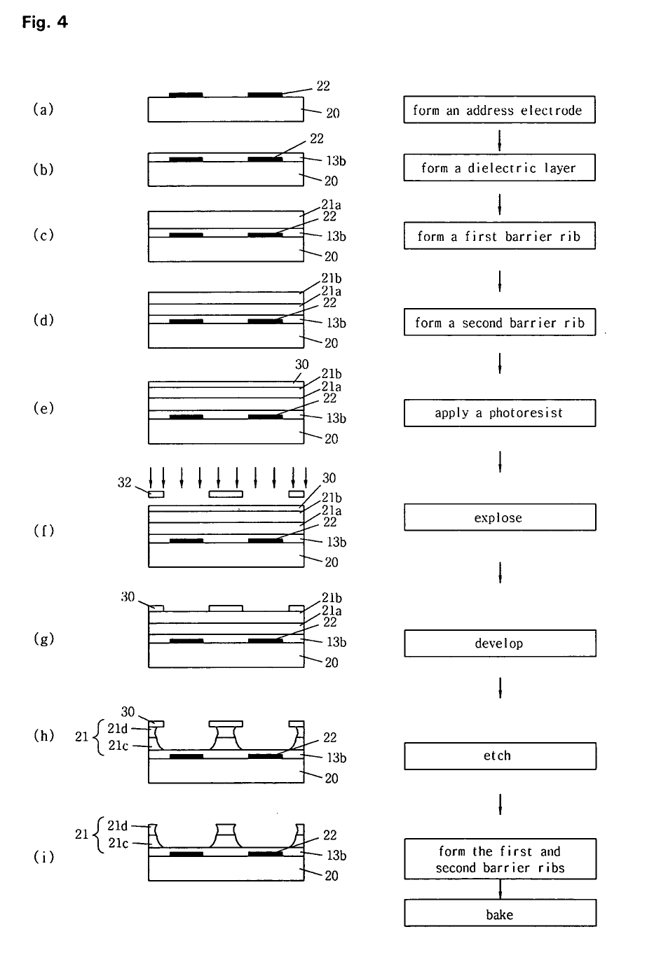

FIG. 4 is a process view sequentially showing a process of manufacturing a plasma display panel according to the present invention.

First, in step (a), an address electrode 22 is formed on a rear glass substrate 20 having a constant width and height. In step (b), a dielectric layer 13b is formed on the address electrode 22.

In step (c), a first barrier rib material layer 21a is formed on the dielectric layer 13b using the sandblast method. At this time, the first barrier rib material layer 21a has a high etch rate due to the variation of the composite.

In step (d), a second barrier rib material layer 21b is formed on the first barrier rib material layer 21a. At this time, the second barrier rib material layer 21b has a lower etch rate than the first barrier rib material layer 21a due to the variation of the composite

As such, the etch rate of barrier rib material layer depends on the composition of the barrier rib material. In other words, a barrier rib material includes a glass powder which is an inorganic powder, a vehicle which is an organic matter, and a filler. The filler includes Al2O3, TiO2 or ZnO. At this time, the more the content of Al2O3 and TiO2 is, the lower the etch rate of barrier rib material is, and the less the content of Al2O3 and TiO2 is, the higher the etch rate of barrier rib material is. On the contrary, the more the content of ZnO is, the higher the etch rate of barrier rib material is, and the less the content of ZnO is, the lower the etch rate of barrier rib material is. The etch rate of barrier rib material may be controlled depending on the additive oxide used upon manufacturing the glass powder. In addition, the etch rate of barrier rib material may also be controlled depending on the diameter of the glass powder particle. Further, the etch rate of barrier rib material may also be changed depending on a kind of binder constituting the vehicle.

In step (e), a photoresist 30 is applied on the second barrier rib material layer 21b. In step (f), a photomask 32 having a predetermined pattern is placed on the photoresist 30, and then the photo resist 30 is allowed to be cured through illuminating the light. This process is referred to as exposing process.

After undergoing the exposing process, if in step (g) the photoresist 30 not cured through the developing process is washed out and then in step (f) the etch solution and sandblast perform an etching, then the barrier rib 21 comprising the first barrier rib layer 21c and the second barrier rib 21d is formed. At this time, the etch rate of the first barrier rib material layer 21a located in lower part is higher than that of the second barrier rib material layer 21c located in upper part, and thus the width of lower part of the finally-formed barrier rib 21 may be formed small. In addition, the etch rate of the second barrier rib material layer 21b is lower than that of the first barrier rib material layer 21a, and thus the width of middle part of the finally-formed barrier rib 21 may be formed great. Accordingly, the finally-formed barrier rib 21 may have a big width of upper part as well as a small width of lower part. Thus, not only structural stability of the barrier rib 21 may be secured, but the maximum area of the discharge cell may also be secured. As the maximum area of the discharge cell may be secured, the brightness of the plasma display panel is improved.

Afterwards, drying and then baking of the formed barrier rib 21 consisting of the first barrier rib layer and the second barrier rib layer completes the barrier rib 21.

At this time, the barrier rib 21 consisting of the first barrier rib layer 21c and the second barrier rib layer 21d is formed through either method of etchings through the sandblast method or the etch solution.

Thereafter, in step (i), a phosphor layer is formed between the barrier ribs 21, and a rear glass substrate 20 is completed through baking.

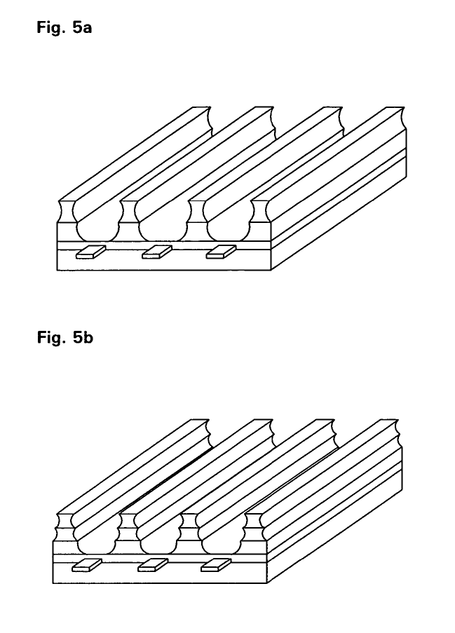

Although the barrier rib is formed which comprises 2 layers in which the a first barrier rib material layer 21a and a second barrier rib material layer 21b is stacked as shown in FIG. 5a in an embodiment of the present invention, however the barrier rib may be formed which comprises more than 3 layers in which more than 3 barrier rib material layers different form one another are stacked. At this time, as becoming more distant from the glass substrate, so barrier rib material layer with low etch rate is stacked thereon.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of manufacturing a plasma display panel comprising the steps of stacking a plurality of barrier rib material layers with different etch rate from each other on a glass substrate; and
forming the barrier rib through etching said plurality of barrier rib material layers with different etch rate from each other

2. The method as claimed in claim 1, wherein as becoming more distant from said glass substrate, so barrier rib material layer with low etch rate is stacked thereon.

3. The method as claimed in claim 1, further comprising the steps of forming a photoresist on the top barrier rib material layer after stacking said barrier rib material layer;
exposing said photoresist using a mask; and
developing a pattern formed through said exposing.

4. The method as claimed in claim 1, wherein said etching is performed using a sandblast method.

5. The method as claimed in claim 1, wherein said etching is performed using a etch solution.

6. The method as claimed in claim 1, wherein each of said plurality of barrier rib material layers with different etch rate from each other includes a filler, whose content is different from each other.

7. The method as claimed in claim 6, wherein said filler includes one or more than one of Al2O3, TiO2, and ZnO, whose content is different from each other.

8. The method as claimed in claim 1, wherein each of said plurality of barrier rib material layers with different etch rate from each other includes a glass powder, wherein an additive oxide added to said glass powder is different from each other.

9. The method as claimed in claim 8, wherein the diameter of a particle of said glass powder is different from each other.

10. The method as claimed in claim 1, wherein each of said plurality of barrier rib material layers with different etch rate from each other includes a vehicle, wherein said vehicle includes a binder different from each other.

11. A plasma display panel comprising a glass substrate; and
a barrier rib consisting of a plurality of barrier rib material with different etch rate from each other formed on said glass substrate.

12. A plasma display panel as claimed in claim 11, wherein as becoming more distant from said glass substrate, so barrier rib material layer with low etch rate is stacked in said barrier rib.

13. The plasma display panel as claimed in claim 11, wherein each of said plurality of barrier rib material with different etch rate from each other includes a filler, whose content is different from each other.

14. The plasma display panel as claimed in claim 13, wherein said filler includes one or more than one Al2O3, TiO2 and ZnO, whose content is different from each other.

15. The plasma display panel as claimed in claim 11, wherein each of said plurality of barrier rib material with different etch rate from each other includes a glass powder, wherein the additive oxide added to said glass powder is different from each other.

16. The plasma display panel as claimed in claim 15, wherein the diameter of a particle of said glass powder is different from each other.

17. The plasma display panel as claimed in claim 11, wherein each of said plurality of barrier rib material with different etch rate from each other includes a vehicle, wherein said vehicle includes a binder different from each other.
